(19) United States
(12) Patent Application Publication
(10) Pub. No.: US 2007/0258258 A1
(43) Pub. Date: Nov. 8, 2007

(54) Illuminating door handle and its base for car

(76) Inventor: Weng-Shih Wang, Taipei (TW)

Correspondence Address: Weng-Shih, Wang, P.O.Box 166-13, Taipei, Taiwan, 115, TW

(21) Appl. No.: 11/429,586

(22) Filed: May 8, 2006

(51) Int. Cl. B60Q 1/26

(52) U.S. Cl. 362/501

(57) ABSTRACT

A car door handle and its base can emit light in the darkness with warning effects. An emitting light door handle 1 includes a door handle 10 secured to car door surface; a mask 20 pervious to light secured to corresponding car door surface, and an emitting light device 30 secured between said door handle 10 and mask 20 pervious to light. Said emitting light device includes an LED (light emitting diode) projects light source to the mask pervious to light. An emitting light base 2 adapted to the emitting light door handle 1 includes a base 60 pervious to light shaped as a concaved housing inlaid into car door surface, and an emitting light device 70 secured to a back of said base 60, said emitting light device 70 includes an LED (light emitting diode) 71 projects light source to the base 60 pervious to light.

### FIELD OF THE INVENTION

The present invention is related to an illuminating door handle and its base for a car.

### GROUND OF THE INVENTION

Generally, means for transport as a vehicle, its illumination and warning devices are installed to both front and rear ends. Even a rear-view mirror can be equipped with a turn signal. When driving in the opposite directions, two cars approach to a passing bay or road intersection with poor sight line, said illumination and warning devices can eliminate accidents such as side collisions.

Construction of a vehicle, front and rear doors occupied significant areas on both lateral sides, but a door is not equipped with an illuminating device. It causes dimmed lateral sides in the night. Though a person skilled in the art have provided luminescence pieces installed to the surface of a car to emit light, but luminescence pieces consuming power leads to a shorter life expectancy. Therefore, drivers are not willing to accept such promotion about luminescence pieces.

Accordingly, the present invention is to provide a car adorned with an illuminating device not only having shinning effect on both sides but also sparing energy and being assembled to a car door easily.

### SUMMARY OF THE INVENTION

Point against aforesaid problems, the present invention is to provide door handles emitting light on all lateral doors of a car, and a base combined to said handle comprising:

An emitting light car door handle 1 is characterized in that a door handle 10 secured to a first side facing outward of a car door; a mask 20 pervious to light secured to the first side of corresponding car door; an emitting light device 30 secured to a PCB (published circuit board, hereinafter brief as PCB) disposed between said door handle 10 and mask 20 pervious to light; said emitting light device 30 includes an LED (light emitting diode, hereinafter brief as LED) projects light source to the mask 20 pervious to light.

According to aforesaid emitting light car door handle, electric circuit of an emitting light device 30 is joined together to an electric circuit of a car.

According to aforesaid emitting light car door handle, a solar panel 50 mounted onto a first side facing outward of a mask 20 pervious to light, said emitting light device 30 installed with an energy exchanger 32 can convert solar energy into electric power, further storing converted electric power in a battery 33.

According to aforesaid emitting light car door handle, an emitting light device 30 includes an IC (integrated circuit, hereinafter brief as IC) 34.

According to aforesaid emitting light car door handle, a mask 20 pervious to light consists of a base 21 secured to a first side of a door handle 10, and a lid 22 pervious to light inlaid into a first side of the base 21.

According to aforesaid emitting light car door handle, a door handle is a handle 10A operated by exerting pressure against thereto.

According to aforesaid emitting light car door handle, a door handle is a handle 10B operated by pulling manipulation.

Furthermore, an emitting light base 2 coupled to an emitting light door handle 1 characterized in that a base 60 pervious to light shaped as a concaved housing inlaid into a first side of a car door, a first side of the housing is adapted to an emitting light handle 1; an emitting light device 70 secured to a PCB disposed on a second side of a base 60; said emitting light device 70 includes an LED 71 projects light source to a base 60 pervious to light.

According to aforesaid emitting light car door handle, an electric circuit of emitting light device 70 is joined together to an electric circuit of a car.

According to aforesaid emitting light car door handle, an electric circuit of emitting light device 70 is joined together to an electric circuit of a car door handle emitting light device 1.

According to aforesaid emitting light car door handle, said emitting light device 30 includes IC 34.

### EFFECT AND FUNCTION

The advantages and benefits can be achieved by embodying the aforesaid car door handle to emit light as following:

When a base or a door handle equipped with an emitting light device, both lateral sides of the car have shinning effect. Thereby, the car door is added with a warning effect, or as a turn light when changing direction.

Car door handle and its base can emit light by converting natural solar energy into electricity and stored in a battery; therefore, it can save energy.

Car door handle with a base has a simple structure, which is easy to assemble to car surface by the users.

### BRIEF DESCRIPTION OF DRAWINGS

FIG. 1: shows an exploded view of a first embodiment of the present invention;

FIG. 2: shows an assembled view of a first embodiment of the present invention;

FIG. 3: shows an exploded view of a second embodiment of the present invention;

FIG. 4: shows an assembled view of a third embodiment of the present invention;

FIG. 5: shows an exploded view of a fourth embodiment of the present invention;

FIG. 6: show an assembled view of a fourth embodiment of the present invention; and

FIG. 7: shows a schematic view of the present invention in use.

### DETAILED DESCRIPTION OF THE PREFERRED EMBODIMENTS

The description is described in detail according to the appended drawings hereinafter:

### First Embodiment

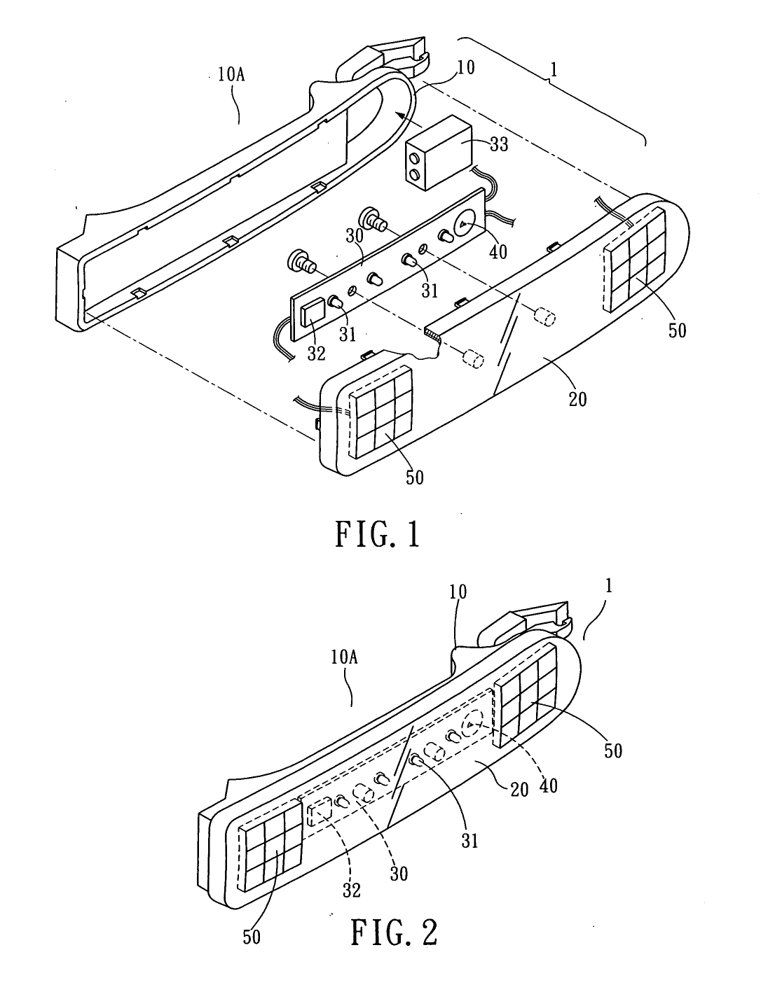

As shown in FIGS. 1 and 2, an exploded and an assembled view of a first embodiment of an emitting light car handle are illustrated. An emitting light car door handle 1 includes a door handle 10 secured to a first side facing outward of a car door; a mask 20 pervious to light is secured to a first side facing outward of a corresponding car door; and an emitting light device 30 is secured to a PCB (published circuit board, hereinafter brief as PCB) disposed between said door handle 10 and mask 20 pervious to light. Said emitting light device 30 includes an LED (light emitting diode. Hereinafter brief as LED) 31 can project light source to a mask 20 pervious to light.

Said door handle 10 is a handle 10A operated by exerting pressure against thereto, once the user presses the handle by a thumb, the door can be opened promptly; handle 10A is a well-known prior art popular on the market, there is no further discussion in detail about handle 10A.

Said mask 20 pervious to light can be secured to a first side facing outward of a door handle 10 by a plurality of ribs fit into mortises respectively. Or a mask 20 can be secured to a first side facing outward of a car door by screwing. Even a mask 20 can be secured to a first side facing outward of a car door by gluing them together.

Electric circuit of said emitting light device 30 can be joined together to an electric circuit of a car to induce a voltage from car battery. Or a mask 20 pervious to light can be adorned with a solar panel 50 onto its first side facing outward. Meanwhile, the emitting light device 30 is equipped with an energy exchanger 32, which is used to convert solar power into electricity, in other words, sunshine or solar energy is first converted into a heat energy absorbed by the solar panel, and then the heat energy is converted into electric power; finally, the electric power is stored in a battery 33.

Said solar panel 50 coupled to a light-dependent resistor, when light energy absorbed by the solar panel is exceeded an upper threshold value, the battery starts to be charged with converted electric power. Conversely, a solar energy is insufficient to meet the lower threshold value, the emitting light device 30 start emitting light. However, the light energy absorbed by the solar panel is accumulated between the upper and lower threshold values, the battery is not being charged, and the emitting light device is not being emitted light therefrom.

PCB of said emitting light device 30 further-is installed with at least an IC 34 to control LED 31 to emit light in an intermittent mode, glittering mode, or in cycles.

### Second Embodiment

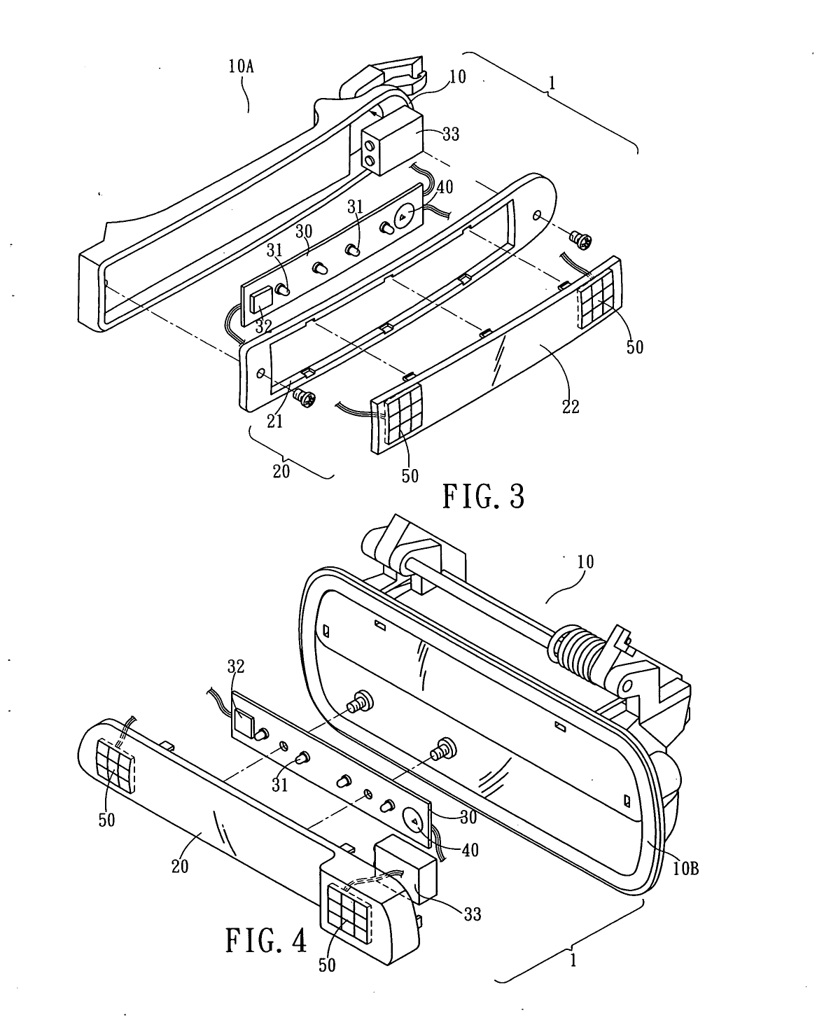

As shown in FIG. 3, an exploded view of an emitting light door handle is illustrated. The second embodiment is different from the first embodiment as the former having a mask 20 pervious to light consists of a base 21 secured to a first side of a door handle 10, and a lid 22 pervious to light inlaid into a first side of a base 21. The color of lid 22 pervious to light can be changed whenever the users have a liking for a selection. Therefore, different warning colors can be shown on the lateral sides of a car. A watertight effect can be improved due to the lid pervious to light is further shielded a door handle.

### Third Embodiment

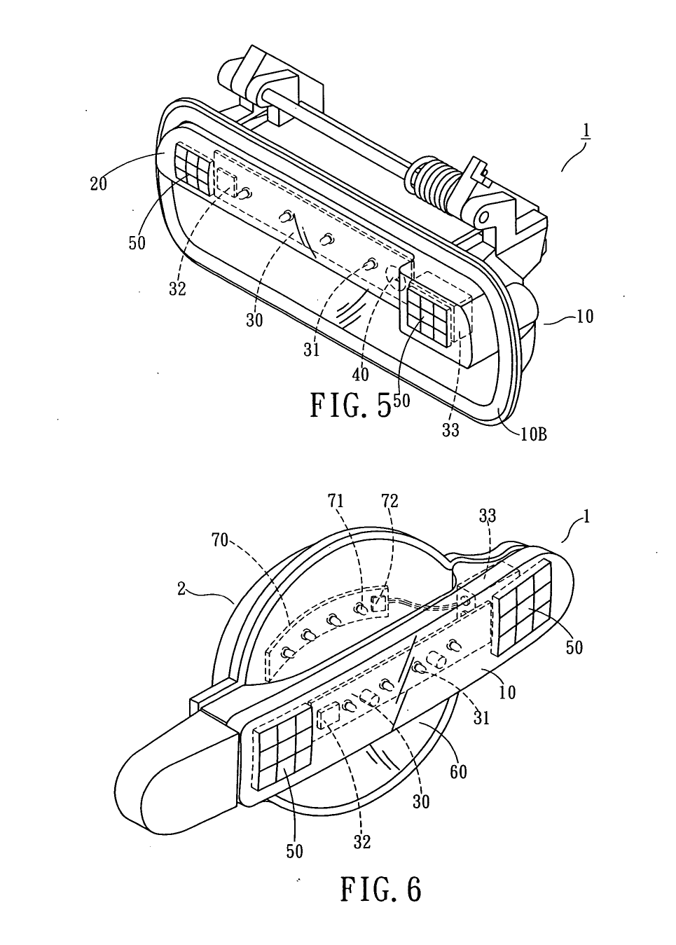

As shown in FIGS. 4 and 5, an exploded and an assembled view of an emitting light door handle are illustrated. In which, an emitting light car door handle 1 comprises a door handle 10 secured to a first side of a car door; a mask 20 pervious to light is secured to a first side of corresponding door; and an emitting light device 30 is secured to a PCB disposed between said door handle and a mask. Said emitting light device 30 includes an LED 31 can project light source onto a mask 20 pervious to light.

The third embodiment is different from a first embodiment as the former has a door handle 10B operated by pulling manipulation. Whenever the users pull out the handle, the car door can be opened promptly. As a door handle 10B pulling open is also a well-known prior art popular on the market, so there is no further discussion in detail about handle 10B.

As shown in FIG. 6, an emitting light base 2 adapted to an emitting light door handle 1 is illustrated. The base 2 includes a base 60 pervious to light, which is shaped as a concaved housing inlaid into a first side facing outward of a car door, is adapted to a first side of a car door 1 (exemplified by a door handle 10A operated by exerting pressure against thereto); an emitting light device 70 is secured to a PCB disposed on a second side of said base 60. Said emitting light device 70 includes an LED 71 can project light source to a base 60 pervious to light.

Said base 60 pervious to light is inlaid into a sheet metal of the car door, it results in a user's hand, when gripping a handle 10A, to avoid from rubbing with the sheet metal. As it is also a well-known prior art, so there is no further discussion in detail about a base inlaid into a sheet metal.

Said emitting light device 70 has an electric circuit can be joined together to an electric circuit of a car, therefore, the emitting light device 70 can share the power to induce a voltage from battery 22.

Moreover, an emitting light device further includes at least an IC 72 to control the LED to emit light in an intermittent mode, a glittering mode, or in cycles.

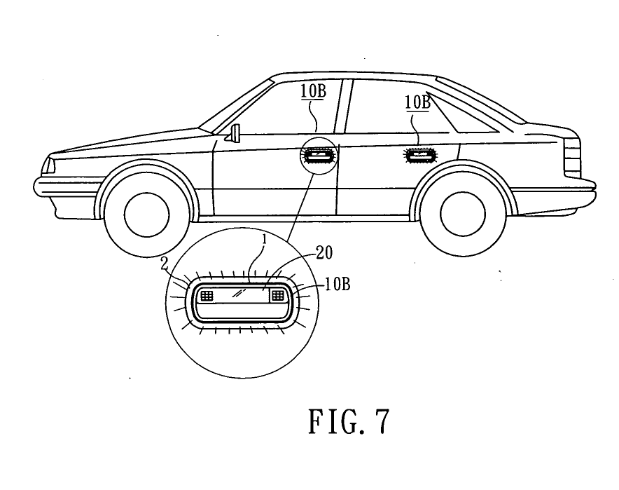

As shown in FIG. 7, a schematic view of the present invention is illustrated. In which, a front and a rear door of a car are adorned with an emitting light door handle 1 with a base 2. When both of the door handle and the base are emitting light at the same time, a warning effect is achieved. And, the door handle and the base emitting light can be cooperated with turn light of the car, therefore, when the car is turning direction, one lateral side adorned with emitting light door handle and its base can be glittering to emit light, thereby, a turn light with shinning effect is to indicate changing direction of a car.

What is we claimed:

1. An emitting light door handle of a car comprising:
a door handle secured to a first side facing outward of a car door; a mask pervious to light secured to a first side of corresponding car door;
an emitting light device secured to a PCB (published circuit board, hereinafter brief as PCB) disposed between said door handle and mask pervious to light; said emitting light device includes an LED (light emitting diode, hereinafter brief as LED) projects light source to the mask pervious to light.

2. An emitting light car door handle according to claim 1 wherein an electric circuit of an emitting light device is joined together to an electric circuit of a car.

3. An emitting light car door handle according to claim 1 wherein a solar panel mounted onto a first side facing outward of a mask pervious to light, said emitting light device installed with an energy exchanger can convert solar energy into electric power, further storing converted electric power in a battery.

4. An emitting light car door handle according to claim 1 wherein an emitting light device includes at least an IC (integrated circuit, hereinafter brief as IC).

5. An emitting light car door handle according to claim 1 wherein a mask pervious to light consists of a base secured to a first side of a door handle, and a lid pervious to light inlaid into a first side of the base.

6. An emitting light car door handle according to claim 1 wherein a door handle is a handle operated by exerting pressure against thereto.

7. An emitting light car door handle according to claim 1 wherein a door handle is a handle operated by pulling manipulation.

8. An emitting light base coupled to an emitting light door handle according to claim 1 comprising:
a base pervious to light shaped as a concaved housing inlaid into a first side of a car door, a first side of the housing is adapted to an emitting light handle;
an emitting light device secured to a PCB disposed on a second side of a base; said emitting light device includes an LED projects light source to a base pervious to light.

9. An emitting light base according to claim 8 wherein electric circuits of an emitting light base and an emitting light device are joined together to an electric circuit of a car.

10. An emitting light base according to claim 8 wherein electric circuits of emitting base and emitting light device are joined together to an electric circuit of said emitting light door handle of a car door.

11. An emitting light base according to claim 8 wherein said emitting light device includes at least an IC.
